(19) United States
(12) Patent Application Publication
(10) Pub. No.: US 2018/0202121 A1
(43) Pub. Date: Jul. 19, 2018

(54) AQUATIC CONTAINMENT MATERIAL AND METHOD OF USE

(71) Applicant: Canadian Floating Fence Corporation, Calgary, Alberta (CA)

(72) Inventors: Stephen Russell NEAL, Calgary (CA); Mark Andrew NEAL, Calgary (CA)

(73) Assignee: Canadian Floating Fence Corporation, Calgary, Alberta (CA)

(21) Appl. No.: 15/742,849

(22) PCT Filed: Jul. 8, 2016
(86) PCT No.: PCT/CA2016/050804

§ 371 Date: Jan. 8, 2018

Related U.S. Application Data
(60) Provisional application No. 62/190,075, filed on Jul. 8, 2015.

(51) Int. Cl. E02B 15/06; C02F 1/40; C02F 1/28; B01D 17/02; E02B 15/10; E02B 15/08; E02B 15/04

(52) U.S. Cl. CPC E02B 15/06; C02F 1/40; C02F 1/285; C02F 2101/32; E02B 15/101; E02B 15/0842; E02B 15/045; B01D 17/0202

(57) ABSTRACT

An aquatic containment material and method of using the same for containing a contaminant in a body of water. The containment material includes a deflection layer permeable to water and with low permeability to the contaminant. A containment layer is connected with the deflection layer and is also permeable to water and with low permeability to the contaminant. The containment material has tensile strength, permittivity to water, and rigidity selected to maintain a vertical position or other selected shape at an expected flow rate across the containment material in a body of water in which the containment material is designed to be used for a given application.

### CROSS REFERENCE TO RELATED APPLICATIONS

This application claims the benefit of priority of U.S. Provisional Patent Application No. 62/190,075, filed Jul. 8, 2015, which is hereby incorporated by reference.

### FIELD

The present disclosure relates generally to materials for containment of a contaminant in a body of water.

### BACKGROUND

When hydrocarbons, industrial effluent, algae, or other undesirable fluids or slurries are present in a body of water, a common approach to damage mitigation is use of a containment boom, fence, or other barrier to mitigate or prevent the spread of the fluids or slurries throughout the body of water. A containment boom provides a wall extending across the water line that restricts the undesirable fluid or slurry from diffusing beyond the containment boom. The wall may extend to the bottom of the body of water or only partway, and components of the boom supporting the wall may be floating, anchored, or both, to secure the wall around the undesirable fluid or slurry. The boom may be stationary or may be towed to collect and contain the fluid or slurry similarly to a dragnet. Materials used in manufacturing the wall are selected to provide a wall that prevents the particular fluid or slurry being contained from diffusing through the wall.

### SUMMARY

Previous containment booms include walls made from materials selected to achieve a given result depending on the fluid or slurry being contained. In some cases, boom walls are prepared from vinyl, which prevents diffusion but also disrupts water flow. In other cases, boom walls are prepared from porous materials, which allow diffusion of water while retaining some fluids or slurries (e.g. silt, algae, weeds, plastics, etc.) but lack the structural strength of vinyl or other materials. Some previous booms may also be susceptible to failure from winds and currents as low as 0.5 knots, with some vinyl booms rolling up under such currents. It is, therefore, desirable to provide a material for containing undesirable fluids or slurries present in a body of water or other aquatic feature.

Herein provided is a containment material for use in containing, restricting, redirecting, or otherwise controlling the diffusion of fluids or slurries in a body of water or other aquatic feature. The containment material may for example be used to prepare a wall in a containment boom, floating fence, or other aquatic barrier. The containment material includes at least two layers: a deflection layer facing the fluid or slurry and a containment layer facing water to be isolated from the fluid or slurry. The deflection layer (e.g. a woven geotextile or other material, vinyl with apertures, etc.) allows passage of water in both directions across the deflection layer and prevents or reduces the flow of the fluid or slurry passing through the deflection layer to the containment layer. The containment layer (e.g. a nonwoven material, a nonwoven geotextile, a spunbond material, a flashspun material, etc.) also allows passage of water in both directions across the deflection layer and reduces or prevents the fluid or slurry flow from passing through the containment layer to further mitigate contamination of the water to be isolated from the fluid or slurry across the containment material from by the fluid or slurry and a redundancy in mitigating flow of the fluid or slurry across the containment material.

The containment material has a density selected for locating a system including the containment material (e.g. the containment material combined with floating spars, the containment material combined with buoys, the containment material anchored between stationary spars, etc.) in a body of water at a position that crosses a surface of the body of water. The containment material has a tensile strength and permittivity to water that allows the containment material to resist damage when presenting a large surface area to water flow such as when crossing a strong current or while being towed. The containment material has a rigidity for remaining substantially vertical or in a different selected shape while extending above a surface of the body of water. The rigidity, the tensile strength, or both, of the containment material may be provided in part by a distinct support layer, which may be located between the deflection and containment layers. The support layer (e.g. a geogrid, etc.) may provide additional support to the deflection and containment layers, and minimal obstruction to flow of either water, or the fluid or slurry.

In a first aspect, the present disclosure provides an aquatic containment material and method of using the same for containing a contaminant in a body of water. The containment material includes a deflection layer permeable to water and with low permeability to the contaminant. A containment layer is connected with the deflection layer and is also permeable to water and with low permeability to the contaminant. The containment material has tensile strength, permittivity to water, and rigidity selected to maintain a vertical position or other selected shape at an expected flow rate across the containment material in a body of water in which the containment material is designed to be used for a given application.

In a further aspect, the present disclosure provides an aquatic containment material comprising: a deflection layer permeable to water and having a low permeability for a selected contaminant; and a first containment layer connected with the deflection layer, the first containment layer permeable to water and having a low permeability for the selected contaminant. The aquatic containment material has a tensile strength and permittivity to water for containing the contaminant in water having a selected flow rate across the aquatic containment material. The aquatic containment material has a rigidity for remaining in a selected shape along a selected distance between anchor points for the aquatic containment material.

In some embodiments, the aquatic containment material comprises a support layer connected with the deflection layer and with the first containment layer for providing the rigidity. In some embodiments, the support layer is located intermediate the deflection layer and the first containment layer. In some embodiments, the support layer is directly connected with the first containment layer. In some embodiments, the support layer is directly connected with the deflection layer. In some embodiments, the support layer is connected with the deflection layer along substantially the entire extent of a height of the deflection layer. In some embodiments, the support layer is connected with the deflection layer along substantially the entire extent of a height of the support layer. In some embodiments, a height of the deflection layer is less than a height of the support layer. In some embodiments, the support layer is connected with the containment first layer along a portion of the height of the support layer for defining a containment zone between the containment first layer and the support layer; the containment zone extends between a first point along the height of the support layer and a second point along the height of the support layer; and the first point is intermediate a first end of the support layer and a second end of the support layer. In some embodiments, the first point is located proximate the first end of the support layer. In some embodiments, the second point is located proximate the second end of the support layer. In some embodiments, the second point is located at a submerged point along the height of the support layer that would be located below a surface of a body of water in which the aquatic containment material may be located, the submerged point located intermediate the second end of the support layer and the first point. In some embodiments, a height of the deflection layer is less than a height of the support layer and the second point is coextensive with the deflection layer. In some embodiments, the material further comprising a second containment layer intermediate the support layer and the deflection layer. In some embodiments, the material further comprising a third containment layer intermediate the second containment layer and the deflection layer. In some embodiments, the third containment layer comprises a spunbond sorbent material. In some embodiments, the support layer comprises a geogrid.

In some embodiments, the deflection layer comprises a woven geotextile.

In some embodiments, the first containment layer comprises a spunbond sorbent material.

In some embodiments, the first containment layer comprises a nonwoven geotextile.

In some embodiments, the containment material includes an absorbent material connected with the deflection layer for absorbing the contaminant. In some embodiments, the absorbent material extends from the deflection layer substantially perpendicular to a height of the containment material at a point along the height of the containment material corresponding to a surface of a body of water in which the containment material is deployed for contacting the surface of the body of water.

In some embodiments, the contaminant comprises silt, hydrocarbons, algae, or industrial effluent.

In some embodiments, the containment first layer comprises a material for sorbing the contaminant.

In some embodiments, the selected shape is substantially vertical along a selected height above a portion of the containment material corresponding to a surface of a body of water in which the containment material is located.

In some embodiments, the selected distance corresponds to a separation distance between neighboring support members for the containment material.

In a further aspect, the present disclosure provides a boom comprising: a plurality of buoyant spars, the buoyant spars each comprising: a buoyant portion for providing buoyancy in a body of water; and a ballast portion for orienting the spars in the body of water; and a plurality of sections of a containment material, each section extending for a section length between neighboring buoyant spars, the containment material comprising: a deflection layer permeable to water and having a low permeability for a selected contaminant; and a first containment layer connected with the deflection layer, the first containment layer permeable to water and having a low permeability for the selected contaminant. The containment material has a tensile strength and permittivity to water for containing the contaminant in water at a selected flow rate. The buoyant spars provide buoyancy to locate the containment layer in the body of water at a selected height above a surface of the body of water and a selected depth below the surface of the body of water. The containment material has a rigidity for remaining substantially vertical at the selected height above the surface of the body of water along the section length between neighboring buoyant spars.

In some embodiments, the selected height above the surface of the body of water is substantially half of the selected depth below the surface of the body of water.

In some embodiments, the boom includes at least one material attachment point on at least one section of the containment material. In some embodiments, the boom includes at least one upper material attachment point and at least one lower material attachment point on the at least one section of the containment material.

In some embodiments, the boom includes at least one material attachment point on the at least one buoyant spar. In some embodiments, the boom includes at least one upper material attachment point and at least one lower material attachment point on the at least one buoyant spar.

In some embodiments, the boom includes at least one connection member extending along at least one section of the containment material. In some embodiments, the boom includes at least one upper connection member and at least one lower connection member on the at least one containment material section.

In some embodiments, the containment material further comprises a support layer connected with the deflection layer and with the first containment layer for providing the rigidity. In some embodiments, the support layer is located intermediate the deflection layer and the first containment layer. In some embodiments, the support layer is directly connected with the first containment layer. In some embodiments, the support layer is directly connected with the deflection layer. In some embodiments, the support layer is connected with the deflection layer along substantially the entire extent of a height of the deflection layer. In some embodiments, the support layer is connected with the deflection layer along substantially the entire extent of a height of the support layer. In some embodiments, a height of the deflection layer is less than a height of the support layer. In some embodiments, the support layer is connected with the containment first layer along a portion of the height of the support layer for defining a containment zone between the containment first layer and the support layer; the containment zone extends between a first point along the height of the support layer and a second point along the height of the support layer; and the first point is intermediate a first end of the support layer and a second end of the support layer. In some embodiments, the first point is located proximate the first end of the support layer. In some embodiments, the second point is located proximate the second end of the support layer. In some embodiments, the second point is located at a submerged point along the height of the support layer that would be located below a surface of a body of water in which the aquatic containment material may be located, the submerged point located intermediate the second end of the support layer and the first point. In some embodiments, a height of the deflection layer is less than a height of the support layer and the second point is coextensive with the deflection layer. In some embodiments, the boom includes a second containment layer intermediate the support layer and the deflection layer. In some embodiments, the boom includes a third containment layer intermediate the second containment layer and the deflection layer. In some embodiments, the third containment layer comprises a spunbond sorbent material. In some embodiments, the support layer comprises a geogrid.

In some embodiments, the deflection layer comprises a woven geotextile.

In some embodiments, the first containment layer comprises a spunbond sorbent material.

In some embodiments, the first containment layer comprises a nonwoven geotextile.

In some embodiments, the boom includes an absorbent material connected with the deflection layer for absorbing the contaminant. In some embodiments, the absorbent material extends from the deflection layer substantially perpendicular to a height of the containment material at a point along the height of the containment material corresponding to a surface of a body of water in which the containment material is deployed for contacting the surface of the body of water.

In some embodiments, the contaminant comprises silt, hydrocarbons, algae, or industrial effluent.

In some embodiments, the containment first layer comprises a material for sorbing the contaminant.

In some embodiments, the selected shape is substantially vertical along a selected height above a portion of the containment material corresponding to a surface of a body of water in which the containment material is located.

In some embodiments, the selected distance corresponds to a separation distance between neighboring support members for the containment material.

In a further aspect, the present disclosure provides a method of containing a contaminant in a body of water comprising: providing an aquatic containment material with a tensile strength and permittivity to water for containing the contaminant in the body of water at a selected flow rate across the containment material, and a rigidity for remaining substantially vertical at a selected height along a selected length between anchor points for the aquatic containment material, the aquatic containment material comprising: a deflection layer permeable to water and having a low permeability for the selected contaminant; and a containment layer connected with the containment letter, the containment layer permeable to water and having a low permeability for a selected contaminant; locating the aquatic containment material in the body of water, with the deflection layer facing a contaminated portion of the body of water including at least a portion of the contaminant and with the containment layer facing open water with a lower concentration of the contaminant than the contaminated portion; and securing the aquatic containment material in the body of water to restrict passage of the contaminant through the deflection layer and the containment layer, and across the aquatic containment material, for containing the contaminant.

In some embodiments, locating the aquatic containment material in the body of water comprises locating the aquatic containment material at least 6 inches above a surface of the water. In some embodiments, locating the aquatic containment material in the body of water comprises locating the aquatic containment material between about 6 and about 24 inches above the surface of the water.

In some embodiments, locating the aquatic containment material in the body of water comprises securing the aquatic containment material between a series of floating spars. In some embodiments, the aquatic containment material and the series of floating spars comprise the floating boom as described herein. In some embodiments, locating the aquatic containment material in the body of water comprises towing the containment material through the body of water. In some embodiments, the containment material comprises a support layer connected with the deflection layer and with the containment layer for providing the rigidity, and the containment layer the support layer is connected with the containment first layer along a portion of the height of the support layer for defining a containment zone between the containment first layer and the support layer, the method further comprising containing the contaminant in the containment zone. In some embodiments, a surface contaminant is contained within the containment zone.

In some embodiments, locating the aquatic containment material in the body of water comprises anchoring the aquatic containment material to a floor of the water body, a shore, a buoy, or a combination thereof.

In some embodiments, the selected contaminant comprises silt, hydrocarbons, algae, or industrial effluent.

In a further aspect, the present disclosure provides an aquatic containment material comprising: a deflection layer comprising a woven geotextile, the deflection layer permeable to water and having a low permeability for a selected contaminant; a containment layer comprising a nonwoven spunbond fabric connected with the deflection layer, the containment layer permeable to water and having a low permeability for the contaminant; and a support layer comprising a geogrid connected with the deflection layer and with the containment layer. The aquatic containment material has a tensile strength and permittivity to water for containing the contaminant in water having a selected flow rate across the containment material. The aquatic containment material has a rigidity for remaining substantially vertical at a selected height along a selected length between anchor points for the aquatic containment material.

In some embodiments, the contaminant comprises hydrocarbons, silt, algae, or industrial effluent.

In a further aspect, the present disclosure provides an aquatic containment material comprising: a first containment layer comprising a nonwoven geotextile permeable to water and having a low permeability for hydrocarbons; a support layer comprising a geogrid connected with the first containment layer; a second containment layer comprising the nonwoven geotextile connected with the support layer; a third containment layer comprising a spunbond nonwoven fabric permeable to water and having a low permeability for hydrocarbons; and a deflection layer comprising a woven geotextile connected with the containment layer, the deflection layer permeable to water and having a low permeability for hydrocarbons. The aquatic containment material has a tensile strength and permittivity to water for containing the contaminant in water at a selected flow rate. The aquatic containment material has a rigidity for remaining substantially vertical at a selected height along a selected length between anchor points for the aquatic containment material.

In some embodiments, the aquatic containment material includes an absorbent material connected with the first containment layer opposite the support layer for absorbing the hydrocarbons. In some embodiments, the absorbent material extends from the deflection layer substantially perpendicular to a height of the containment material at a point along the height of the containment material corresponding to a surface of a body of water in which the containment material is deployed for contacting the surface of the body of water.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached figures, in which features sharing reference numerals with a common final two digits of a reference numeral correspond to similar features across multiple figures (e.g. the deflection layer 40, 140, 240, 340, 440, 540, 640, 740, 840, 940, 1040, etc.).

FIG. 1 is a cross-section of a containment material in a body of water;

FIG. 2 is a partial cutaway schematic of a containment material;

FIG. 3 is a cross-section of the containment material of FIG. 2 in a body of water;

FIG. 4 is a cross-section of a containment material in a body of water;

FIG. 5 is an exploded cross-section of the containment material of FIG. 4 in a body of water;

FIG. 6 is a cross-section of a containment material in a body of water;

FIG. 7 is a cross-section of a containment material in a body of water;

FIG. 8 is a cross-section of a containment material in a body of water;

FIG. 9 is a schematic of a floating boom including a containment material;

FIG. 10 is a schematic of the floating boom of claim 9 in a body of water;

FIG. 11 is a schematic of a floating boom including a containment material being towed through a body of water;

FIG. 12 is a cross-section of the floating boom of FIG. 11 being towed through a body of water;

FIG. 13 is a cross-section of a floating boom including a containment material being towed through a body of water;

FIG. 14 is a schematic of a floating boom including a containment material;

FIG. 15 is a cross-section of the floating boom of FIG. 14 being towed through a body of water;

FIG. 16 is a schematic of a floating boom including a containment material and an absorbent material; and

FIG. 17 is a cross-section of the boom of FIG. 16.

### DETAILED DESCRIPTION

Generally, the present disclosure provides a containment material and method for containing, restricting, or otherwise controlling the diffusion of a fluid or slurry present in a body of water or other aquatic feature. The fluid or slurry would typically include organisms or chemicals (e.g. hydrocarbons, silt, algae, weeds, plastics, industrial effluent, etc.). Such fluids and slurries may result from, for example, spills, construction debris, or industrial activity. The containment material may be included in a containment boom or fence with buoyant spars or anchored spars for locating the containment material in a body of water with a selected height of the containment material extending upwards from the surface of the water. The containment material may be applied in a method that includes providing the containment boom or fence in the water to contain or otherwise restrict flow or diffusion of the fluid or slurry. Where buoyant and unanchored spars are applied, the boom or fence may be towed through the water to capture, contain, and collect the selected fluid or slurry.

The containment material includes a deflection layer and a containment layer. When deployed in a body of water, the deflection layer faces the fluid or slurry and the containment layer faces clean water to be isolated from the fluid or slurry. The containment and deflection layers, and any structural supports for these layers, may be prepared from materials such as nylon, polypropylene, high-density polyethylene, ultrahigh-density polyethylene, other plastics, ceramics, or any other suitable materials. Such materials in combination as a containment material may provide tensile strength, permittivity to water, and rigidity at a density suitable for locating the containment material at a position in the water that crosses a surface of the body of water.

The deflection layer allows passage of water in both directions across the deflection layer and reduces passage of the fluid or slurry across the deflection layer. A woven geotextile or other fabric may provide tensile strength and rigidity at a thickness with reasonable permittivity for water. A woven geotextile or other fabric will also typically have a low density for mitigating contribution of the containment layer to the overall density of the containment material, and in some cases may have a density below the density of water. Examples of such woven fabrics include Propex Style 1199 woven geotextile by Propex Fabrics Inc., Nilex 1198, Nilex 1199, Nilex 2002, Nilex 2004, Nilex 2006, Nilex 2016, Nilex 2019, Nilex 2044, Nilex 2119, Nilex 270HP, Nilex 300HTM, Nilex 370HP, Nilex 400HTM, Nilex 600HTM, and Nilex 770HP woven geotextiles by Nilex Civil Environmental Group, and Spectra fiber by Honeywell (for low temperature applications). The Nilex woven geotextiles

have permittivity values of between 0.05 and 1.50 sec⁻¹ (tested by ASTM-D4491), resulting in water flow rates of between 4 and 115 gpm/ft². Nilex 1198, Nilex 1199, Nilex 2002, Nilex 2004, Nilex 2006, Nilex 2016, Nilex 2019, Nilex 2044, and Nilex 2119 have grab tensile strength values (tested by ASTM-D4632) of between 200 and 600 lbs. Nilex 270HP, Nilex 300HTM, Nilex 370HP, Nilex 400HTM, Nilex 600HTM, and Nilex 770HP have wide width tensile values (tested by ASTM-D4595) of between 2640×2460 and 7200×5760 lbs/ft. or tensile modulus at 2% strain of between 30,000 and 90,000 lbs/ft. All tensile strength, permittivity, flexural stiffness/rigidity, and other values relating to materials described herein are as reviewed based on websites that appear to be maintained bt the indicated corporate entities.

Where the deflection layer is not intended to sorb a contaminant, a mesh prepared from vinyl or another impermeable material with apertures may also be used. The apertures in a mesh prepared from vinyl may provide blockage of between about 60% and about 95%, or any suitable blockage to provide a selected permittivity for a given application.

The containment layer allows passage of water in both directions across the containment layer and prevents or significantly reduces passage of the fluid or slurry across the containment layer. The containment layer provides a barrier to contamination of water facing the containment layer by the fluid or slurry. The deflection layer may reduce passage of the fluid or slurry to a lower degree than the containment layer. The material used to manufacture the containment layer may be selected with reference to the particular fluid or slurry that is being contained, restricted, or otherwise controlled. The containment layer may also have a selected coefficient of permeability value, resulting in an appropriate permittivity value at a thickness appropriate to the intended application. For example, a nonwoven geotextile or spunbond nonwoven fabric may restrict flow of silt or algae and also have a high coefficient of permeability for water.

A nonwoven geotextile may provide suitable values of tensile strength and permittivity for water at a reasonable thickness for use as the containment layer. A nonwoven geotextile may also have a low density for mitigating contribution of the containment layer to the overall density of the containment material. Examples of a nonwoven geotextile include Nilex 4535, Nilex 4545, Nilex 4504, Nilex 4546, Nilex 4547, Nilex 4550, Nilex 4551, Nilex 4552, Nilex 4553, Nilex 4510, Nilex 4512, Nilex 4516, nonwoven geotextiles by Nilex Civil Environmental Group, which have permittivity values of between 0.7 and 2.0 sec⁻¹ (tested by ASTM-D4491), resulting in water flow rates of between 50 and 150 gpm/ft², and have grab tensile strength values (tested by ASTM-D4632) of between 80 and 380 lbs.

A spunbond nonwoven fabric may provide strength and permittivity for water at a thickness suitable for preparing the containment material. A spunbond nonwoven fabric may also have a low density for mitigating contribution of the containment layer to the overall density of the containment material. Examples of such a spunbond nonwoven fabric include PBN-II spunbond nylon nonwoven fabric by Cerex Advanced Fabrics Inc., Orion spunbond nylon nonwoven fabric by Cerex Advanced Fabrics Inc., SpectraMax spunbond nylon nonwoven fabric by Cerex Advanced Fabrics Inc., and Oil Shark spunbond nylon nonwoven fabric by Cerex Advanced Fabrics Inc. The spunbond nylon fabrics may provide greater sorption of hydrocarbons over a wide range from short chain to long chain hydrocarbons, but have less durability than the nonwoven geotextiles. Where the containment layer includes the spunbond nylon fabrics, the deflection layer may also serve a protective function to increase the life of the containment material relative to use of spunbond nylon fabrics only. In addition to spunbond nonwoven nylon fabrics, spunbond polypropylene, spunbond polyethylene, flashspun polyethylene (e.g. Tyvek by DuPont, etc.), or other fibers may be used.

The containment material has a tensile strength and permittivity to water that allows the containment material to maintain a large surface area exposed to water flow, resisting damage when located in a moving body of water (e.g. wakes, waves, etc.) or when towed through the body of water. The strength and permittivity may be provided by a combination of the properties of the material from which the deflection layer is prepared, the properties of the material from which the containment layer is prepared, and the tensile strength of any other features present in the containment material.

The containment material has a rigidity for remaining substantially vertical or in a different selected shape while extending above the surface of the water to a selected height and for a selected distance. The selected height may be selected with reference to expected wave heights, expected height of surface contaminants floating on a surface of the water, or other considerations. The selected distance may correspond to a distance between neighboring support structures provided for the containment material in a buoyancy system (e.g. spars in a floating boom, stationary spars, buoys, anchor points on a boat, anchor points on the floor of the body of water, etc.). The rigidity and tensile strength of the containment material may be provided in part by a support layer. The support layer may be connected to one or more of the other layers in the containment material and may be located between the deflection and containment layers. The support layer provides support to the deflection and containment layers, and minimal barrier to flow of either water, or the fluid or slurry. A geogrid may provide strength and rigidity for a selected distance of the containment material to remain substantially vertical or in another selected shape when exposed to waves or other disturbances of the body of water. The selected distance may correspond to a distance between any two neighboring support structures provided for the containment material. The geogrid may have a low density for mitigating contribution of the support layer to the overall density of the containment material. Examples of such a geogrid include Type 2 Biaxial Geogrid, Biaxial Geogrid BX1100, Biaxial Geogrid BX1120, Biaxial Geogrid BX1200, Biaxial Geogrid BX1220, and Biaxial Geogrid BX1500 by Tensar International Corporation, Type 1 Biaxial Geogrid, Type 2 Biaxial Geogrid, Type 3 Biaxial Geogrid, by Nilex Civil Environmental Group, and Biaxial Geogrid SBx 11 (Type 1) by GSE Environmental. The Tensar geogrids listed above have ultimate tensile strength MD values of between 12.4 and 27.0 lb/ft (ASTM D4759-02) and flexural stiffness values of between 250,000 and 2,000,000 mgcm (ASTM D7748-12). The Nilex geogrids listed above have tensile strength MD values of between 1028 and 2056 lb/ft (EN ISO 10319) and flexural rigidity values of between 400,000 and 4,000,000 mgcm (ASTM D1388). Biaxial Geogrid SBx 11 (Type 1) have ultimate tensile strength MD values of 12.4 lb/ft (ASTM D6637-01) and flexural stiffness values of 250,000 mgcm (ASTM D5732-01).

The containment material has a density selected for locating a buoyancy system including the containment material (e.g. the containment material combined with floating spars, the containment material combined with buoys, the containment material anchored between stationary spars, etc.) in a body of water at a position that crosses a surface of the body of water. The density of the containment material results from a combination of the densities of the material from which the deflection layer is prepared, the material from which the containment layer is prepared, and the material from which any other features present in the containment material. Where the containment layer is prepared from spunbond fabrics, some materials may provide specific gravities of about 1.14 (e.g. Spectra fiber by Honeywell, etc.). Where the containment layer is prepared from spunbond fabrics, some materials may provide specific gravities of about 0.97 (e.g. PBN-II spunbond nylon nonwoven fabric by Cerex Advanced Fabrics Inc., Orion spunbond nylon nonwoven fabric by Cerex Advanced Fabrics Inc., SpectraMax spunbond nylon nonwoven fabric by Cerex Advanced Fabrics Inc., etc.). Where the support layer includes a geogrid, the specific gravity of the geogrid may be between about 2 and about 15.

The containment material may have a buoyancy selected to stay afloat, in combination with a buoyancy system, at a selected height above a surface of the water, for mitigating spread of the fluid or slurry across the containment material. The containment material may have a rigidity for remaining substantially vertical at the selected height along a selected length of the containment material. The selected length may be a length corresponding to the separation distance between neighboring support structures provided for the containment material when the containment material extends from a selected depth below the surface of the water to the selected height above the surface of the water. In some applications, the containment material may be positioned to extend above the surface of the water by between about 10 and about 24 inches. In some applications, the containment material may be positioned to extend below the surface of the water by between about 20 and about 108 inches.

Use of the materials described above facilitates preparation of a containment material with a low specific gravity. However, a specific gravity of below 1 for all components of the containment material is not necessary, provided that the containment material as a whole has the required buoyancy to stay afloat, in combination with a buoyancy system, at the selected height above a surface of the water, for mitigating spread of the fluid or slurry. In applications where buoys or other flotation are applied to maintain the position of the containment material above the waterline, a containment material with a specific gravity over 1 may be applied. The closer the specific gravity of the containment material is to 1, the more ballast and less buoyancy material are required to maintain the containment material at the selected height above a surface of the water.

The overall permittivity of the containment material is selected as appropriate for a given application. Where the containment material is expected to encounter significant fluid flow (e.g. a towed boom, a stationary boom placed in a fast-moving current for fixed position gated flow, etc.), the permittivity may be selected to allow relatively free flow of water across the containment material. The permittivity may be selected to allow relatively free flow of water across the containment material, mitigating disturbance, deformation, and damage of a boom or floating fence applying the containment material by current or when being towed through the water. The permittivity mitigates the tendency for the containment material to hold back water and take on stress and damage from water flow. Rather than increasing drag and acting as a sail with the water, as would be the case with low permittivity, a high permittivity allows waves and current to pass through with mitigated stress on, and damage to, the containment material. Locating the containment material downstream of the fluid or slurry flow at a normal or close to normal angle with the water flow increases contact between the deflection layer and the fluid or slurry, facilitating any filtration of water carrying the fluid or slurry by the containment material.

Where the containment material is not expected to encounter a significant flow (e.g. used to contain a chemical spill in an essentially stagnant marsh, etc.), the permittivity to water may be selected to be lower. Since the containment material is exposed to much lower flow in such an application compared with towed or fast-moving current applications, the containment material is able to minimize stress resulting from water flow, maintaining its shape and mitigating damage with a lower permittivity to water. In addition, the deflection layer, the containment layer, or both, may be prepared from less durable materials in low-flow applications.

The permittivity of the containment material may be selected to provide a reasonable flow from various ranges of current. The containment material for use in a given application may be designed to filter various contaminants in different water types and with different flow rates of water against the containment material. The low-flow essentially stagnant applications may allow flow across the containment material for sorption of the fluid or slurry onto the containment layer. A flow rate of up to about 1 knot may be observed a creek, inner harbor, marina, or industrial discharge site. Such applications may use a containment material with a permittivity that allows a flow of about 50 gpm/ft². Flow rates of 2 knots or higher may be observed in a river, ocean, or ebbing tide. Such applications, often for fixed position gated flow, may use a containment material with a permittivity that allows a flow of about 110 gpm/ft². Towed applications are typically carried out at between 1 and 2 knots, and would use a containment material with a permittivity that allows a flow of about 80 gpm/ft².

The relative positions of the deflection layer and the containment layer in the containment material, the features of the deflection layer and of the containment layer, and other features of the containment material, are determined in part by the intended application of the containment material in a particular instance. The permittivity, strength, rigidity, and other features of the materials making up the deflection layer and the containment layer, and the containment material more broadly, result in the features of the containment material.

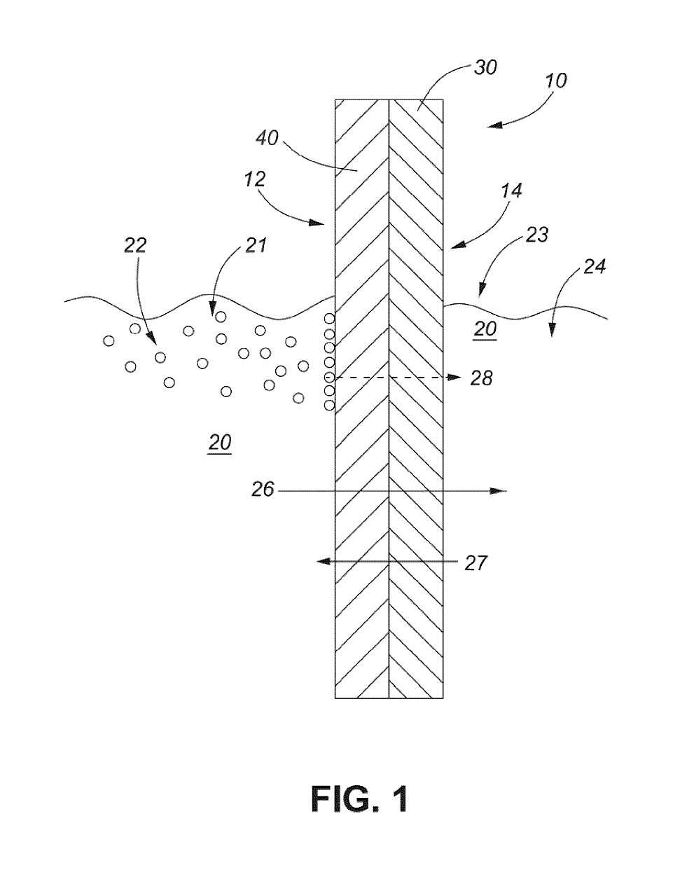

FIG. 1 is a cross-sectional schematic of a containment material 10 positioned substantially vertically in a body of water 20 including a contaminant 21. The containment material 10 crosses a surface 23 of the body of water 20. A contaminant side 12 of the containment material 10 faces a contaminated portion 22 of the body of water 20. A clean side 14 of the containment material 10 faces a clean portion 24 of the body of water 20. Water flow 26 crosses the containment material 10 from the contaminated portion 22 to the clean portion 24. Water flow 27 crosses the containment material 10 from the clean portion 24 to the contaminated portion 22 where there is little current or a current that changes direction (e.g. as a result of wakes in a harbor or other high traffic waterway, etc.). Contaminant flow 28 across the containment material 10 from the contaminated portion 22 to the clean portion 24 is reduced or eliminated by the containment material 10.

The containment material 10 includes a deflection layer 40 that defines the contaminant side 12 and a containment layer 30 that defines the clean side 14. The deflection layer 40 and the containment layer 30 together provide a permittivity of the containment material 10 for allowing passage of water at a selected flow rate appropriate to the intended application of a given examples of the containment material 10. For example, when used in a towed remediation application for chemical spills or algae blooms, the containment material 10 may allow a relatively high flow for the water flow 26 compared with a containment material for use in a relatively stagnant body of water.

A portion of the contaminant 21 may be deflected by the deflection layer 40, preventing the contaminant 21 from passing through the containment material 10. To the extent that the contaminant 21 passes through the deflection layer 40, the contaminant 21 may sorb onto the containment layer 30. For example, where the contaminant 21 is silt and the containment layer 30 is prepared from a nonwoven geotextile, the silt contaminant 21 that passes through the deflection layer 40 may sorb on to the nonwoven geotextile containment layer 30 while water passes through both the deflection layer 40 and the containment layer 30. The contaminant 21 may also sorb onto the deflection layer 40. To the extent that the contaminant 21 reaches the deflection layer 40, the contaminant 21 may sorb onto the deflection layer 40 to a lower degree than onto the containment layer 30. For example, Nilex 2016 nonwoven geotextile by Nilex Civil Environmental Group may be expected to sorb less hydrocarbon contaminant than Tenax Rock-in-Roll by Syntec, LLC, PBN-II spunbond nylon nonwoven fabric by Cerex Advanced Fabrics Inc., Orion spunbond nylon nonwoven fabric by Cerex Advanced Fabrics Inc., SpectraMax spunbond nylon nonwoven fabric by Cerex Advanced Fabrics Inc., or Oil Shark spunbond nylon nonwoven fabric by Cerex Advanced Fabrics Inc.

Without being limited by any particular theory, in addition to preventing or reducing passage of the contaminant 21 across the containment material 10 by sorption, boundary effects at the deflection layer 40 may result from flow of a mixture of water and the contaminant 21 against the deflection layer 40. The boundary effects may result in eddies at the contaminant surface 12, which reduce the amount of contaminant 21 contacting the containment layer 30 and sorbing onto the containment layer 30, leaving the contaminant 21 caught up in an eddy separated from the contaminant surface 12. In addition, the amount of contaminant 21 reaching the containment layer 30 may be reduced as demonstrated in experiments with coloured contaminants

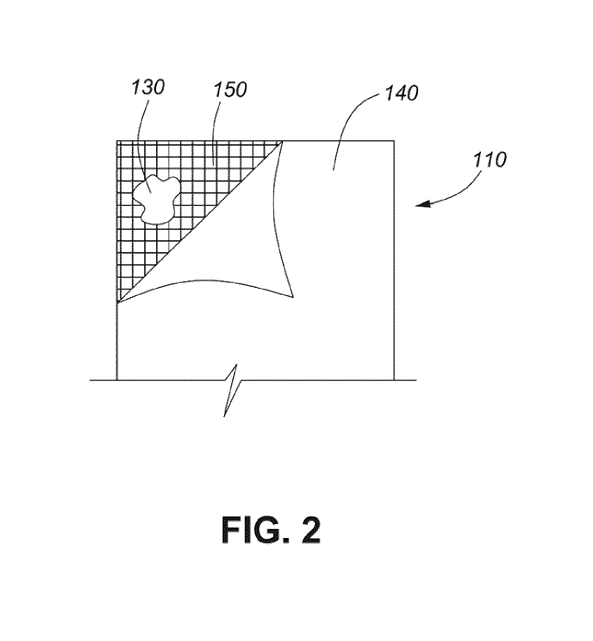

The deflection layer 40 and the containment layer 30 may be connected with each other directly or through an intermediate layer (e.g. the support layer 150 of FIG. 2). Any suitable connection method may be used (e.g. sewing, RF welding, cauterizing, staples, clips etc.).

FIG. 2 shows a containment material 110 with the deflection layer 140 pulled back to show a support layer 150 between the deflection layer 140 and the containment layer 130. The containment layer 130, which is located behind the support layer 150 in FIG. 2, is visible through a cutaway portion of the support layer 150 in FIG. 2.

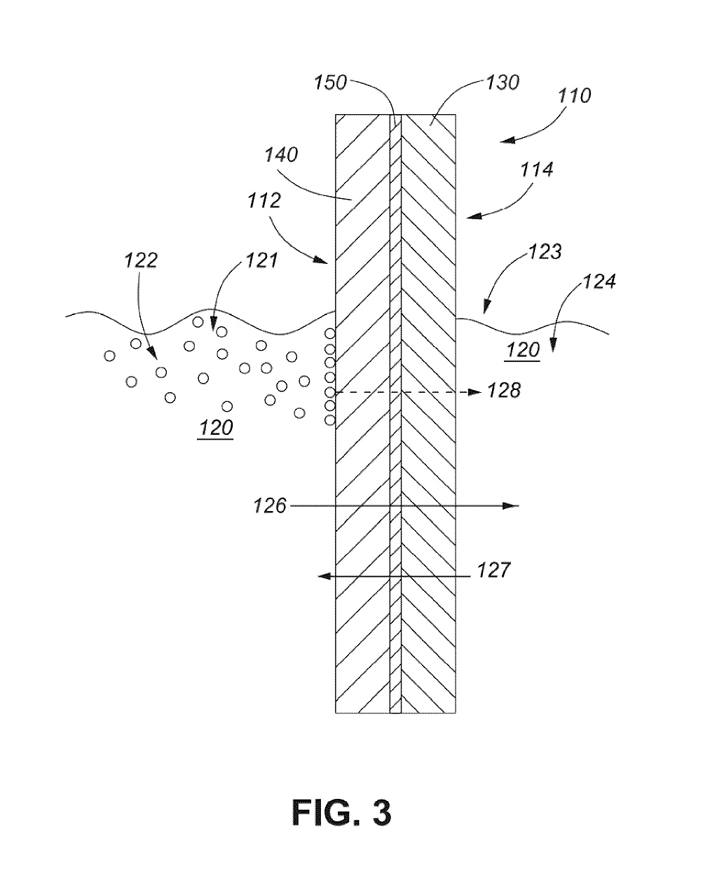

FIG. 3 shows the containment material 110 in the body of water 120 including the contaminant 121. The contaminant side 112 of the containment material 110 faces the contaminated portion 122 of the body of water 120. The clean side 114 of the containment material 110 faces the clean portion 124 of the body of water 120. The water flow 126 crosses the containment material 110 from the contaminated portion 122 to the clean portion 124. The water flow 127 crosses the containment material 110 from the clean portion 124 to the contaminated portion 126 where there is minimal current or a current that changes direction (e.g. as a result of wakes in a harbor or other high traffic waterway, etc.). The contaminant flow 128 across the containment material 110 from the contaminated portion 122 to the clean portion 124 is reduced or eliminated by the containment material 110.

The containment material 110 includes the deflection layer 140 that defines the contaminant side 112 and the containment layer 130 that defines the clean side 114. The deflection layer 140 and the containment layer 130 together provide a permittivity selected to allow passage of water at a selected flow rate appropriate to the intended application of a given examples of the containment material 110. For example, when used in a towed remediation application for chemical spills or algae blooms, the containment material 110 will allow a relatively high flow for the water flow 126 compared with a containment material for use in a relatively stagnant body of water.

A portion of the contaminant 121 may be deflected by the deflection layer 140, preventing the contaminant 121 from passing through the containment material 110. To the extent that the contaminant 121 passes through the deflection layer 140, the contaminant 121 may sorb onto the containment layer 130. For example, where the contaminant 121 is silt and the containment layer 130 is prepared from a nonwoven geotextile, the silt contaminant 121 that passes through the deflection layer 140 may sorb on to the nonwoven geotextile containment layer 130 while water passes through both the deflection layer 140 and the containment layer 130. The contaminant 121 may also sorb onto the deflection layer 140. In most cases, the contaminant 121 will sorb onto the deflection layer 140 to a lower degree than onto the containment layer 130. For example, Nilex 2016 nonwoven geotextile by Nilex Civil Environmental Group may be expected to sorb less hydrocarbon contaminant than Tenax Rock-in-Roll by Syntec, LLC, PBN-II spunbond nylon nonwoven fabric by Cerex Advanced Fabrics Inc., Orion spunbond nylon nonwoven fabric by Cerex Advanced Fabrics Inc., SpectraMax spunbond nylon nonwoven fabric by Cerex Advanced Fabrics Inc., or Oil Shark spunbond nylon nonwoven fabric by Cerex Advanced Fabrics Inc.

In addition to preventing or reducing passage of the contaminant 121 across the containment material 110 by sorption, boundary effects at the deflection layer 140 may result from flow of a mixture of water and the contaminant 121 against the deflection layer 140. The boundary effects may result in eddies at the contaminant surface 112, which reduce the amount of contaminant 121 contacting the containment layer 130 and sorbing onto the containment layer 130, leaving the contaminant 121 caught up in an eddy separated from the contaminant surface 112. In addition, the amount of contaminant 121 reaching the containment layer 130 may be reduced as demonstrated in experiments with coloured contaminants

The containment material 110 includes the support layer 150 connected with the deflection layer 140 and with the containment layer 130. The support layer 150 provides a portion of the tensile strength and rigidity that allows a selected distance of the containment material 110 between any support structures provided for the containment material 110 to remain vertical in the water body 120. The support layer 150 may freely allow passage of water, in which case the permittivity of the containment material 110 may result primarily from the deflection layer 140 and the containment layer 130. A support layer may alternatively be placed externally to the containment layer or externally to the deflection layer (not shown). However, placement of a support layer externally to the deflection layer on the contaminant side may disrupt the continuity of the contaminated side and interfere with the boundary effects (e.g. where the support layer is a geogrid or other biaxial pattern, etc.).

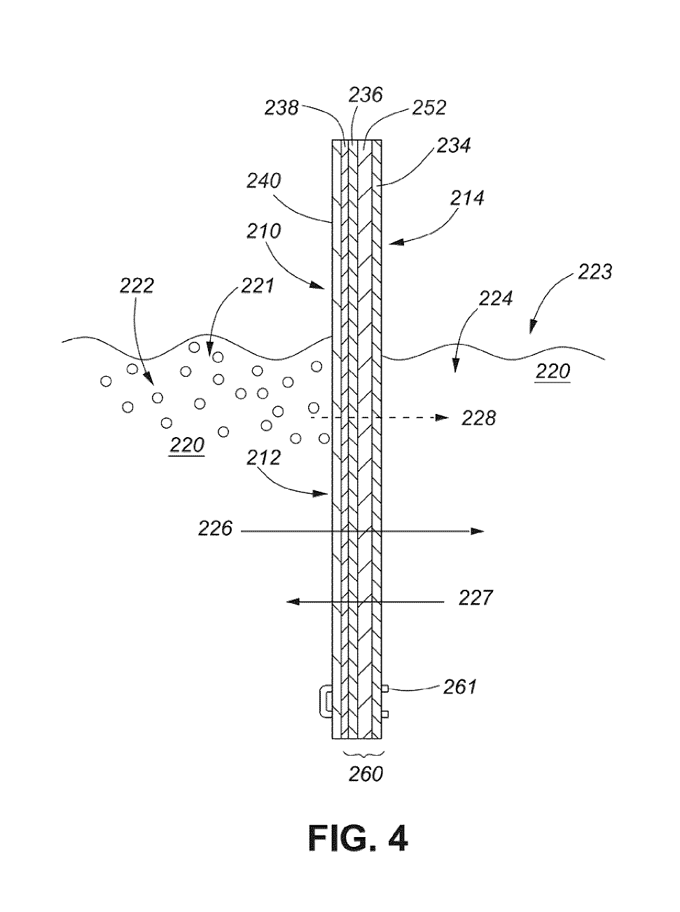

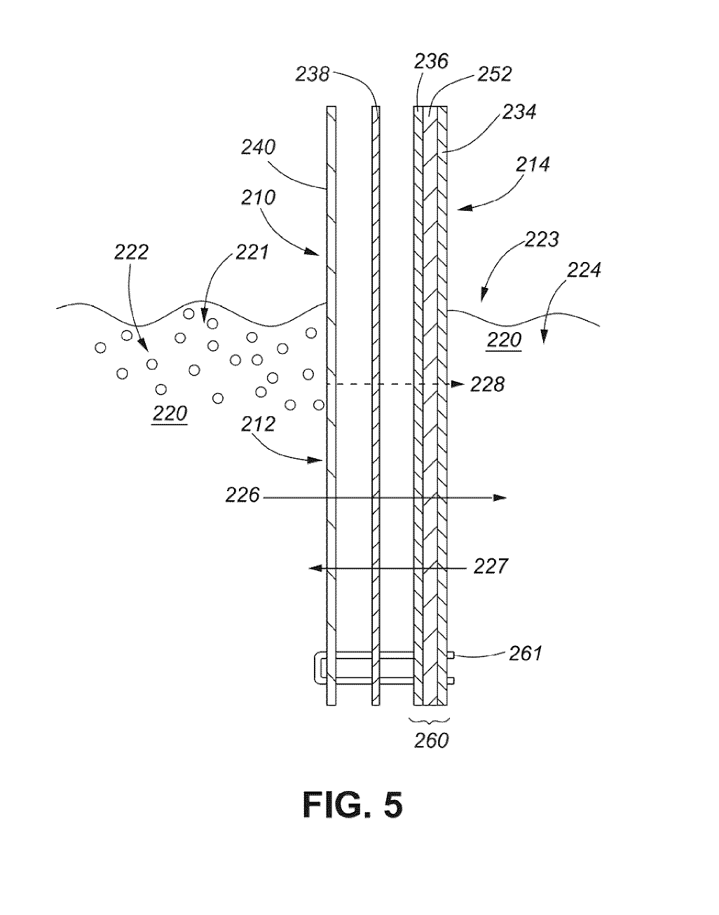

FIGS. 4 and 5 show cross-section assembled and exploded views of a containment material 210 in the body of water 220 including the contaminant 221. The contaminant side 212 of the containment material 210 faces the contaminated portion 222 of the body of water 220. The clean side 214 of the containment material 210 faces the clean portion 224 of the body of water 220. The water flow 226 crosses the containment material 210 from the contaminated portion 222 to the clean portion 224. The water flow 227 crosses the containment material 210 from the clean portion 224 to the contaminated portion 226 where there is little current or a current that changes direction (e.g. as a result of wakes in a harbor or other high traffic waterway, etc.). The contaminant flow 228 across the containment material 210 from the contaminated portion 222 to the clean portion 224 is reduced or eliminated by the containment material 210.

The containment material 210 includes a first containment layer 234, a second containment layer 236, and a third containment layer 238. A support layer 252 is between the first containment layer 234 and the second containment layer 236. Each of the first containment layer 234 and the second containment layer 236 are connected with the support layer 252. The third containment layer 238 is between the second containment layer 236 and the deflection layer 240.

The first containment layer 234, the support layer 252, and the second containment layer 236 may be provided as a single supported containment layer 260. The supported containment layer 260 may include paired sorption materials for the first containment layer 234 and the second containment layer 236, such as nonwoven geotextiles. The first containment layer 234 and the second containment layer 236 may be prepared from the same or different materials. The support layer 252 may include an embedded netting, or a series of support struts. Examples of a supported containment layer 260 include Tenflow 770-2 Double-Sided Geocomposite by Syntec, LLC and Tenax Rock-in-Roll by Syntec, LLC. The Tenax Rock-in-Roll material includes supporting ribs thermally bonded to nonwoven geotextiles and at its standard thickness provides a permittivity of 1.4 sec⁻¹. The supported containment layer 260 is connected with the third containment layer 238 and the deflection layer 240 by staples 261, but any suitable connection method may be applied.

The third containment layer 238 may be a nonwoven spunbond fabric or nonwoven geotextile. Examples of such materials are provided in relation to the containment layer above.

A containment material may also be prepared using a deflection layer connected with a supported containment layer, similar to the containment material 210 without the third containment layer 238 (not shown; for example by preparing the containment materials 10 or 110 in which the respective containment layers 30 or 130 include Tenax Rock-in-Roll by Syntec, LLC.).

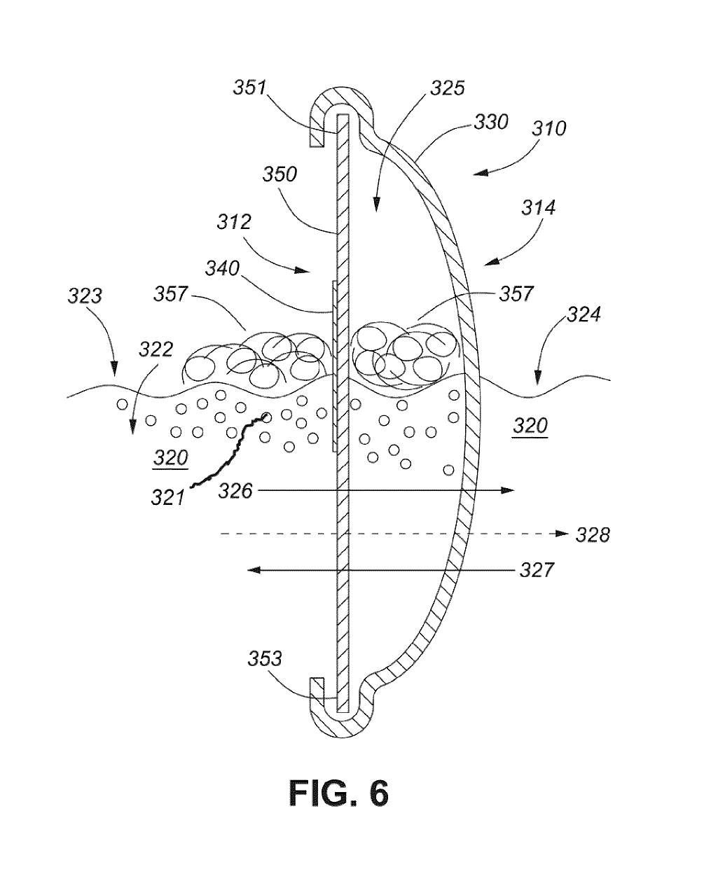

FIG. 6 shows a cross-section of a containment material 310 in the body of water 320 including the contaminant 321 and a surface contaminant 357 floating on the surface 323 of the body of water 320. The contaminant side 312 of the containment material 310 faces the contaminated portion 322 of the body of water 320. The clean side 314 of the containment material 310 faces the clean portion 324 of the body of water 320. The water flow 326 crosses the containment material 310 from the contaminated portion 322 to the clean portion 324. The water flow 327 crosses the containment material 310 from the clean portion 324 to the contaminated portion 326 where there is little current or a current that changes direction (e.g. as a result of wakes in a harbor or other high traffic waterway, etc.). The contaminant flow 328 across the containment material 310 from the contaminated portion 322 to the clean portion 324 is reduced or eliminated by the containment material 310.

The containment material 310 includes the deflection layer 340, the containment layer 330, and the support layer 350. The containment layer 330 is connected to the support layer 350 at a first point proximate a top end 351 of the support layer 350 and at a second point proximate a bottom end 353 of the support layer 350. As a result of the containment layer 330 not being attached to the support layer 350 along the entire height of the support layer 350 between the top end 351 and the bottom end 353, a containment zone 325 is defined between the containment layer 330 and the support layer 350 along the height of the support layer 350 intermediate the first point proximate the top end 351 of the support layer 350 and the second point proximate the bottom end 353 of the support layer 350. To the extent that the contaminant 321 and the surface contaminant 357 cross the deflection layer 340, the contaminant 321 and the surface contaminant 357 may be sequestered in the containment zone 325 by the containment layer 330. When the containment material 310 is towed through the body of water 320 or is otherwise subject to water flow in the body of water 320, the containment layer 330 extends away from the support layer 350, defining the containment zone 325.

The deflection layer 340 extends along a portion of the height of the support layer 350, the height of the support layer 350 being defined when the containment material is positioned substantially vertically as shown in FIG. 6. The deflection layer 340 may extend to a height above the surface 323 of the body of water 320 to exceed the expected height of any surface contaminant 357 and may extend to a depth below the surface 323 of the body of water 320 to exceed the expected depth of any contaminant 321. The shorter extent of the deflection layer 340 along the height of the support layer 350 may reduce the cost and weight of the containment material 310 while still providing a deflection layer 340 where the contaminant 321 and surface contaminant 357 are expected to be present. A portion of the surface contaminant 321 may pass over the deflection layer 340 into the containment zone 325. The support layer 350 may provide a rigidity for the containment material 310 to maintain a substantially vertical shape above the surface 323 of the body of water 320 along a selected length of the containment material 310 between any support structures provided for the containment material 310. The containment layer 330 has a strength and permittivity to water for receiving the water flow 326 against the containment layer 330.

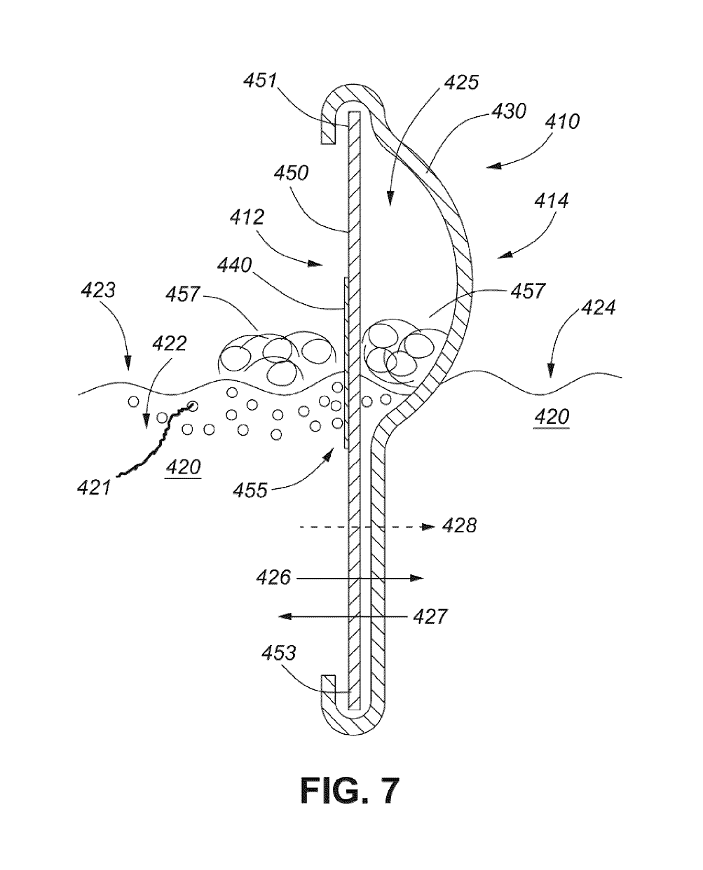

FIG. 7 shows a cross-section of a containment material 410 in the body of water 420 including the contaminant 421 and a surface contaminant 457 floating on the surface 423 of the body of water 420. The contaminant side 412 of the containment material 410 faces the contaminated portion 422 of the body of water 420. The clean side 414 of the containment material 410 faces the clean portion 424 of the body of water 420. The water flow 426 crosses the containment material 410 from the contaminated portion 422 to the clean portion 424. The water flow 427 crosses the containment material 410 from the clean portion 424 to the contaminated portion 426 where there is little current or a current that changes direction (e.g. as a result of wakes in a harbor or other high traffic waterway, etc.). The contaminant flow 428 across the containment material 410 from the contaminated portion 422 to the clean portion 424 is reduced or eliminated by the containment material 410.

The containment material 410 includes the deflection layer 440, the containment layer 430, and the support layer 450. The containment layer 430 is connected to the support layer 450 at the first point proximate the top end 451 of the support layer 450 and at a second point 455 intermediate the top end 451 and the bottom end 453 of the support layer 410. As a result of the containment layer 430 not being attached to the support layer 450 along the entire height of the support layer 450 between the top end 451 and the second point 455 of the support layer 450, the containment zone 425 is defined between the containment layer 430 and the support layer 450 intermediate the second point 455 and the first point proximate the top end 451. The second point 455 may be a submerged point along the height of the support layer 450 that is located below the surface 423 when the containment material 410 is located in the body of water 420. To the extent that the contaminant 421 and the surface contaminant 457 cross the deflection layer 440, the contaminant 421 and the surface contaminant 457 may be sequestered in the containment zone 425 by the containment layer 430. When the containment material 410 is towed through the body of water 420 or is otherwise subject to water flow in the body of water 420, the containment layer 430 extends away from the support layer 450, defining the containment zone 425.

The deflection layer 440 extends along a portion of the height of the support layer 450, the height of the support layer 450 being defined when the containment material is positioned substantially vertically as shown in FIG. 7. The deflection layer 440 may extend to a height above the surface 423 of the body of water 420 to exceed the expected height of any surface contaminant 457 and may extend to a depth below the surface 423 of the body of water 420 to exceed the expected depth of any contaminant 421. The shorter extent of the deflection layer 440 along the height of the support layer 450 may reduce the cost and weight of the containment material 410 while still providing a deflection layer 440 where the contaminant 421 and surface contaminant 457 are expected to be present. A portion of the surface contaminant 421 may pass over the deflection layer 440 into the containment zone 425. The support layer 450 may provide a rigidity to the containment material 410 as a whole for maintaining a substantially vertical shape above the surface 423 of the body of water 420 along a selected distance between any support structures provided for the containment material 410. The containment layer 430 and the support layer 450 together provide strength and permittivity to water for receiving the water flow 426 against the containment layer 430.

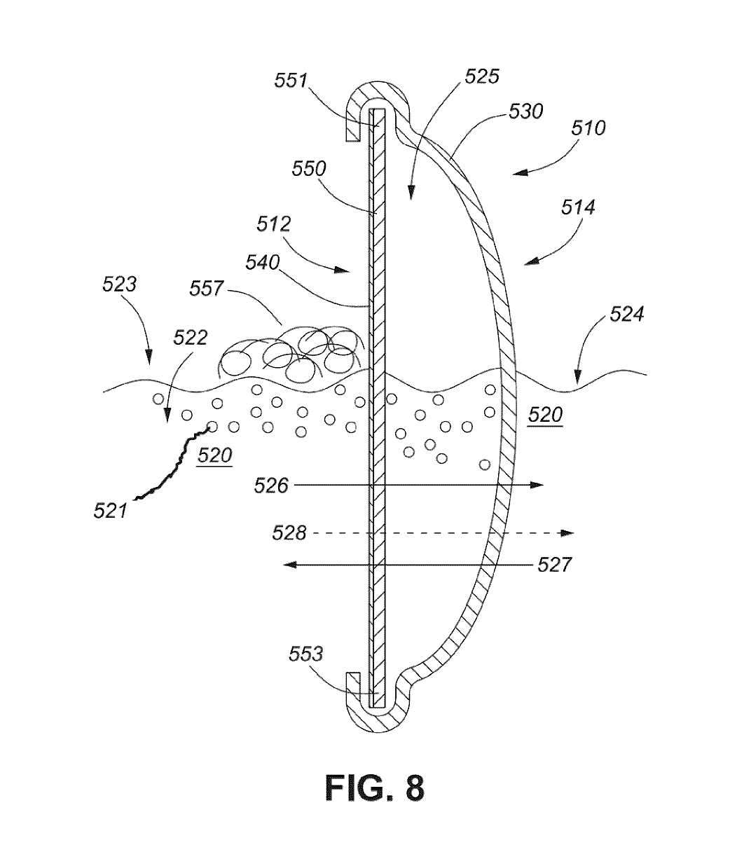

FIG. 8 shows a cross-section of a containment material 510 in the body of water 520 including the contaminant 521 and a surface contaminant 557 floating on the surface 523 of the body of water 520. The contaminant side 512 of the containment material 510 faces the contaminated portion 522 of the body of water 520. The clean side 514 of the containment material 510 faces the clean portion 524 of the body of water 520. The water flow 526 crosses the containment material 510 from the contaminated portion 522 to the clean portion 524. The water flow 527 crosses the containment material 510 from the clean portion 524 to the contaminated portion 526 where there is little current or a current that changes direction (e.g. as a result of wakes in a harbor or other high traffic waterway, etc.). The contaminant flow 528 across the containment material 510 from the contaminated portion 522 to the clean portion 524 is reduced or eliminated by the containment material 510.

The containment material 510 includes the deflection layer 540, the containment layer 530, and the support layer 550. The containment layer 530 is connected to the support layer 550 at the first point proximate the top end 551 of the support layer 550 and the second point proximate the bottom end 553 of the support layer 550. As a result of the containment layer 530 not being attached to the support layer 550 along the entire height of the support layer 550 between the top end 551 and the bottom end 553 of the support layer 550, the containment zone 525 is defined between the containment layer 530 and the support layer 550 along the height of the support layer 550 intermediate the first point proximate the top end 551 of the support layer 550 and the second point proximate the bottom end 553 of the support layer 550. To the extent that the contaminant 521 crosses the deflection layer 540, the contaminant 521 and the surface contaminant 557 may be sequestered in the containment zone 525 by the containment layer 530. The full-length deflection layer 540 extending between the first point proximate the top end 551 and the second point proximate the second end 553 may substantially prevent the surface contaminant 557 from entering the containment zone 525. When the containment material 510 is towed through the body of water 520 or is otherwise subject to water flow in the body of water 520, the containment layer 530 extends away from the support layer 550, defining the containment zone 525.

The deflection layer 540 and the support layer 550 together provide rigidity to the containment material 510 for maintaining a substantially vertical shape above the surface 523 of the body of water 520 along a selected length of the containment material 510 between any support structures provided for the containment material 510. The containment layer 530 and the support layer 550 together provide strength and permittivity to water for receiving the water flow 526 against the containment layer 530.

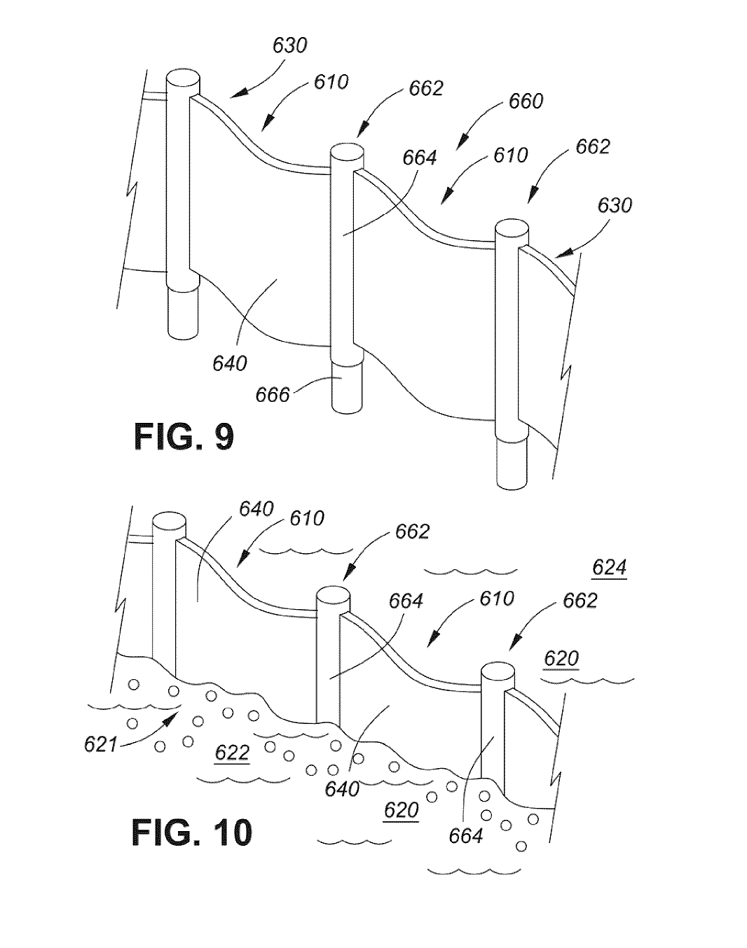

FIG. 9 shows a floating boom 660. The floating boom 660 includes the containment material 610 extending between buoyant spars 662. The buoyant spars 662 each include a buoyant portion 664 and a weighted portion 666. The ballast portions 666 have a density greater than the density of water. The ballast portions 666 may provide the density through any standard means (e.g. weights, apertures to allow entry of water, etc.).

The buoyant portions 664 facilitate floating the containment material 610 while the ballast portions 666 provide density to orient the buoyant spars 662 and the containment material 610 when the floating boom 660 is used in a body of water. The containment material 610 may include any suitable containment material as described or supported herein (e.g. the containment materials 10, 110, 210, 310, 410, 510, 710, 810, 910, 1010, etc.). The densities of the buoyancy portion 664 and the ballast portion 666 of the buoyant spars 662 are selected to locate the containment material 610 in a body of water at a selected height above the surface of the body of water. The containment material 610 has a rigidity for maintaining a substantially vertical shape at the selected height along a length of the distance between neighboring buoyant spars 662.

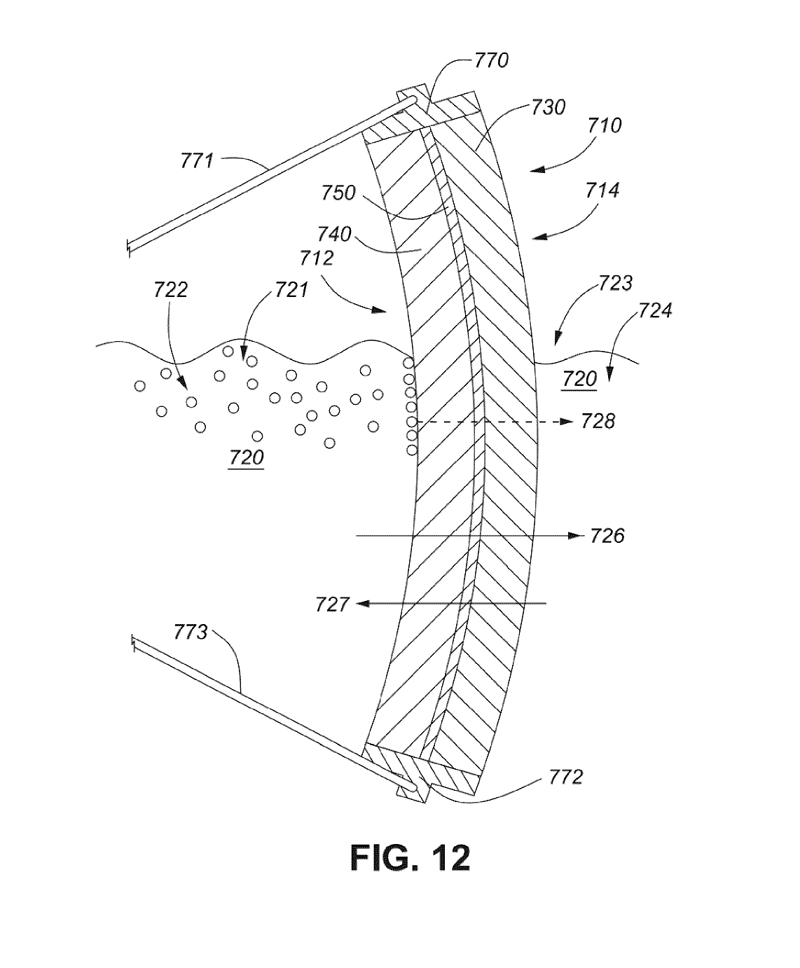

FIG. 10 shows the floating boom 660 floating in the body of water 620. The floating boom 660 is oriented with the deflection layer 640 of the containment material 610 facing the contaminated portion 622 of the body of water 620. The ballast portions 666 (see FIG. 9) are located below the surface 623 of the body of water 620 and the buoyant portions 664 extend above the surface 623 to support the containment material 610. The containment material 610 has a rigidity for maintaining the substantially vertical shape at the selected height along a length corresponding to a distance between adjacent buoyant spars 662. For example, a containment material 610 in which the deflection layer 640 includes a woven geotextile, the containment layer 630 includes a spunbond nonwoven fabric, and the support layer (not shown in FIG. 10; see for example the containment material 710 as shown in FIG. 12) includes a geogrid, may provide the rigidity of the containment material 610 for remaining vertical at a height of between about 6 inches and about 24 inches above the surface 623 of the body of water 620 with a distance of about 4 feet between adjacent buoyant spars 662.

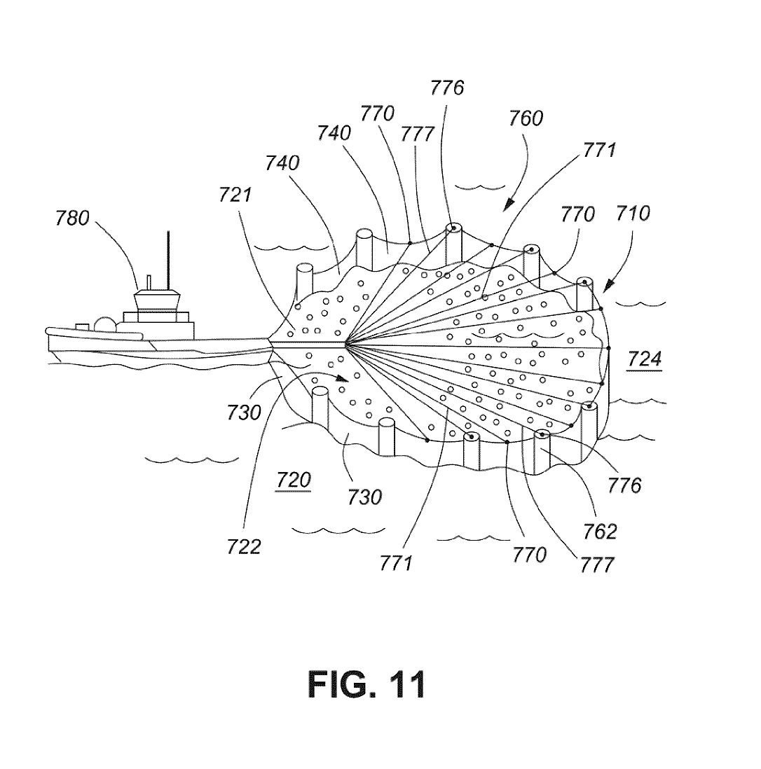

FIG. 11 shows a floating boom 760 being towed by a boat 780 through a body of water 720. The contaminant portion 722 is located within the floating boom 760, facilitating relocating the contaminant 721, which is sequestered within the floating boom 760 by containment material 710 including the deflection layer 740 and the containment layer 730. The floating boom 760 includes the buoyant spars 762 and the containment material 710 extending between the buoyant spars 762. The buoyant spars 762 include upper spar attachment points 776 connected with upper spar towing members 777 (e.g. cables, chains, ropes, etc.). The containment material 710 includes upper material attachment points 770 approximately midway between adjacent buoyant spars 762. The attachment points 770 are connected with upper material towing members 771. The spar upper towing members 777 and upper material towing members 771 are together connected with the boat 780.

FIG. 12 shows a cross-section of the containment material 710 being towed through the body of water 720. A lower material attachment point 772 connected with a lower material towing member 773 is shown. The containment material 710 is bowed out slightly under the force of being towed, with the contaminant 721 being urged against the deflection layer 740.

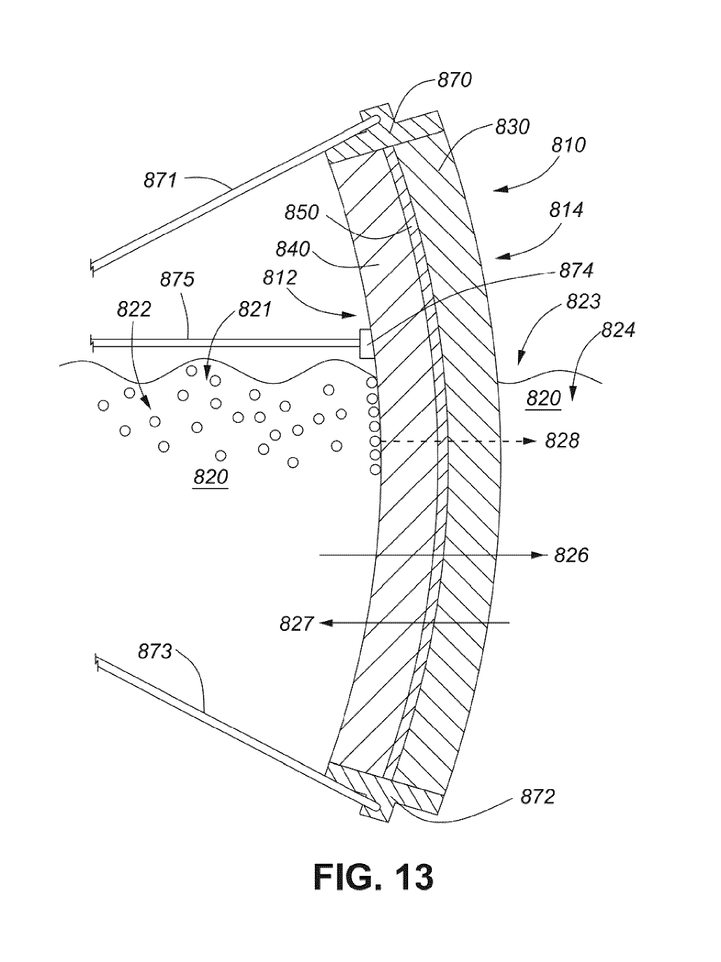

FIG. 13 shows a cross-section of a containment material 810 being towed through the body of water 820. The containment material 810 is similar in most respects to the containment material 710 and further includes a central material attachment point 874 connected with a central material towing member 875. The greater number of attachment points on each section of the containment material between adjacent buoyant spars (not shown in respect of the containment material 810 but similar to the buoyant spars 662, 772 described above) may facilitate towing a containment material with a greater height, lower permittivity to water, or which is otherwise under greater stress and force than would be facilitated with fewer attachment points.

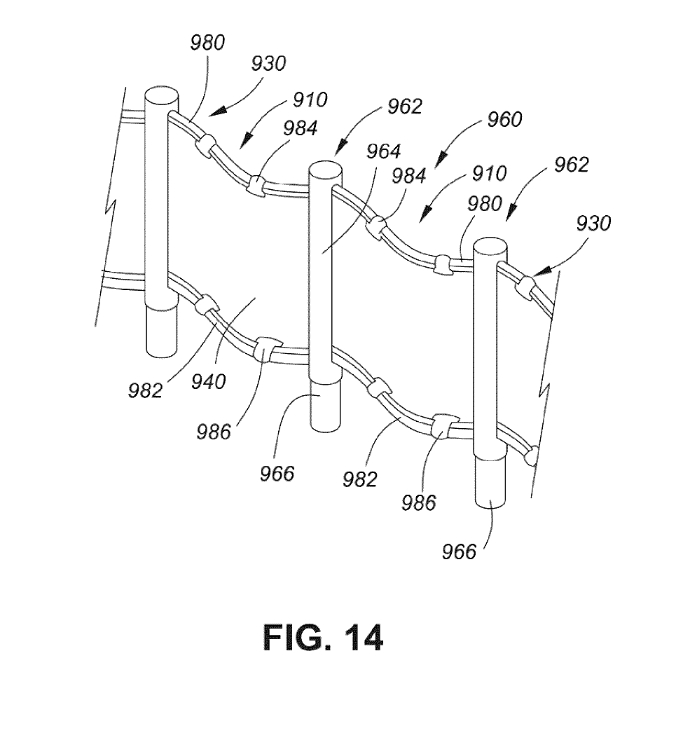

FIG. 14 shows a floating boom 960. The floating boom 960 includes the containment material 910 extending between the buoyant spars 962. The buoyant spars 962 each include the buoyant portion 964 and the weighted portion 966. The ballast portions 966 have a density greater than the density of water. The ballast portions 966 may provide the density through any standard means (e.g. weights, apertures to allow entry of water, etc.). The buoyant portions 964 facilitate floating the containment material 910 while the ballast portions 966 provide density to orient the buoyant spars 962 and the containment material 910 when the floating boom 960 is used in a body of water. The containment material 910 may include any suitable containment material as described or supported herein (e.g. the containment materials 10, 110, 210, 310, 410, 510, 610, 710, 810, 1010, etc.).

An upper attachment member 980 extends along the length of the boom 960, across the containment material 910 and through the buoyant spars 962. The upper attachment member 980 is connected with the containment material at connectors 984. A lower attachment member 982 extends along the length of the boom 960, across the containment material 910 and through the buoyant spars 962. The lower attachment member 982 is connected with the containment material at connectors 986.

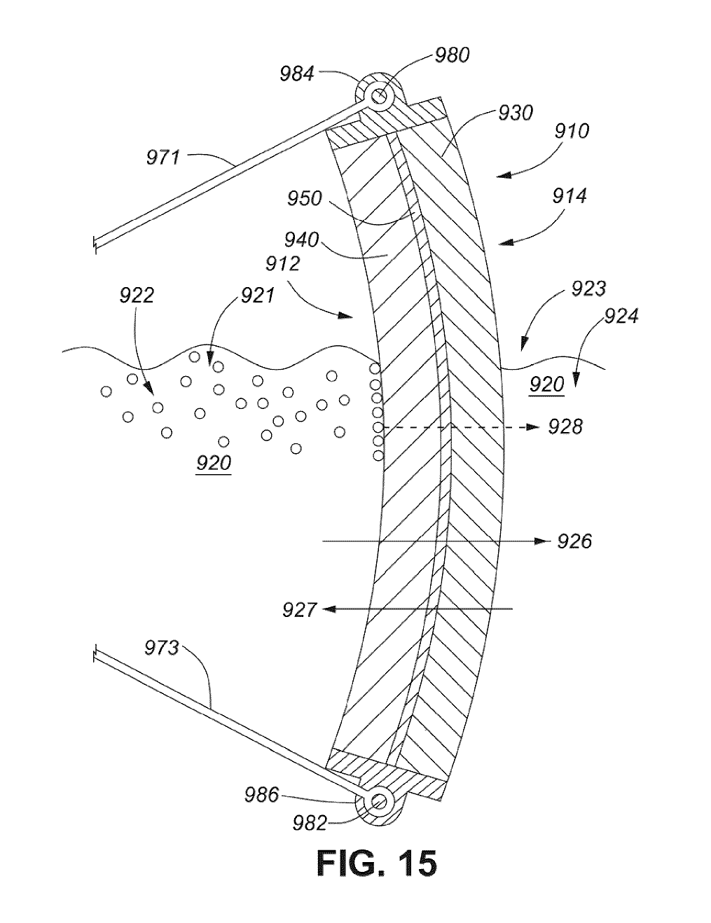

FIG. 15 shows a cross-section of the containment material 910 being towed through the body of water 920. The upper material towing member 971 is connected with the upper attachment member 980. The lower material towing member 973 is connected with the lower attachment member 982.

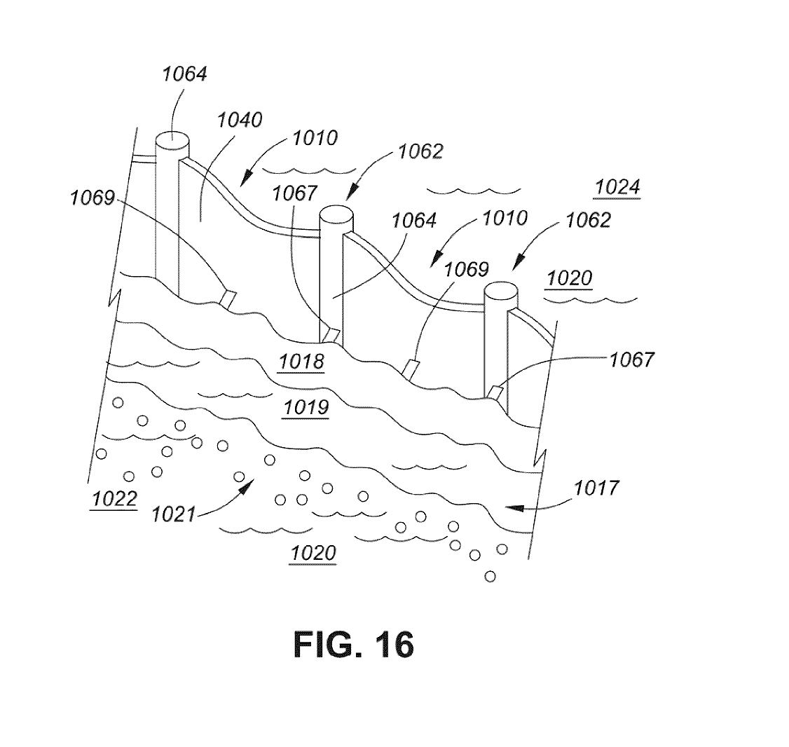

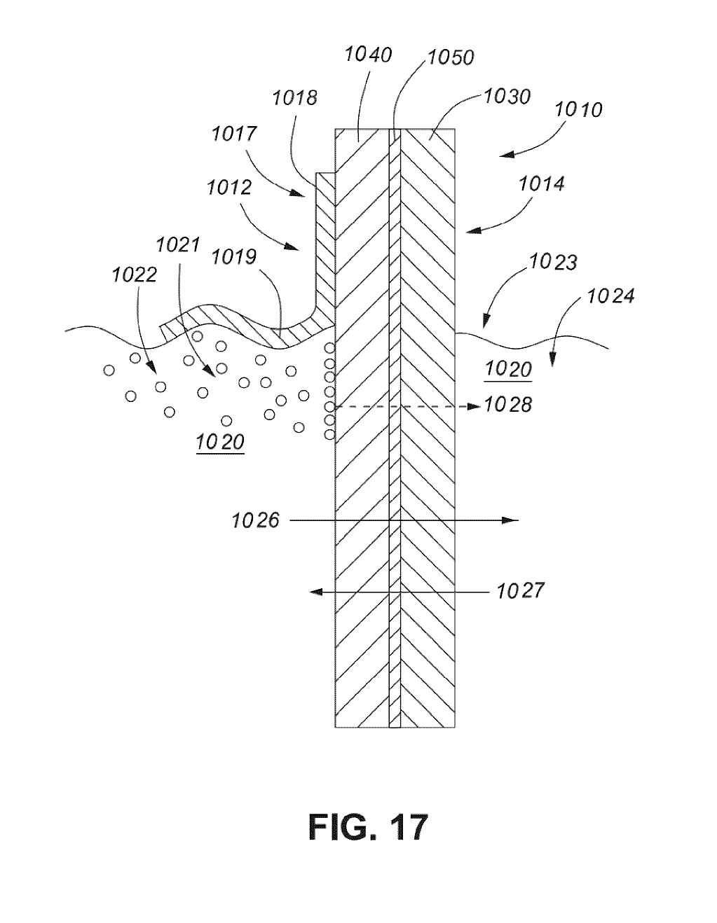

FIGS. 16 and 17 show a floating boom 1060 floating in the body of water 1020. The floating boom 1060 is oriented with the containment side 1012 including the deflection layer 1040 facing the contaminated portion 1022 of the body of water 1020, which includes the contaminant 1021. The clean side 1014 including the containment layer 1030 faces the clean portion 1024. The ballast portions (not shown; see the ballast portions 666 and 966 in FIGS. 9 and 14) are located below the surface 1023 of the body of water 1020 and the buoyant portions 1064 extend above the surface 1023 to support the containment material 1010. The containment material 1010 has a rigidity for maintaining the substantially vertical shape at the selected height along a length corresponding to a distance between adjacent buoyant spars 1062. For example, a containment material 1010 in which the deflection layer 1040 includes a woven geotextile, the containment layer 1030 includes a spunbond nonwoven fabric, and the support layer 1050 (see FIG. 17) includes a geogrid, may provide the rigidity of the containment material 1010 for remaining vertical at a height of between about 6 inches and about 24 inches above the surface 1023 of the body of water 1020 with a distance of about 4 feet between adjacent buoyant spars 1062.

The boom 1010 includes an absorbent material 1017 connected with the deflection layer 1040. The absorbent material 1017 includes a vertical portion 1018 connected with the deflection layer 1040 at containment material connectors 1069 and with the buoyant spars 1064 at spar connectors 1067. The absorbent material 1017 includes a surface portion 1019 extending from the containment material 1010 substantially perpendicular to the containment material 1010. The surface portion 1019 extends from the containment material 1010 at a point along the height of the containment material 1010 corresponding to the surface 1023 of the body of water 1020 in which the containment material 1010 is deployed for contacting the surface 1023 of the body of water 1020.

### Example I

A containment material similar to the containment material 210 shown in FIGS. 4 and 5 was prepared and tested. The containment material included and a deflection layer of Nilex 2016 woven geotextile by Nilex Civil Environmental Group, a supported containment layer of Tenax Rock-in-Roll by Syntec, LLC, and a third containment layer of SpectraMax spunbond nylon nonwoven fabric by Cerex Advanced Fabrics Inc. The tests were directed to determining impact of flow on the containment material, oil spill containment of the containment material in flowing conditions, and standing water oil containment of the containment material.

In the flow impact tests, the containment material was exposed to flow at 90 degrees and at 45 degrees. The following results were observed:

TABLE 1
Flow Impact Test Data at 90 Degree Flow

| | Input Flow | Output Flow | Input Flow | Output | |
|---|---|---|---|---|---|
| | Velocity | Velocity | Rate | Flow Rate | % Flow |
| Trial | (ft/s) | (ft/s) | (Gal/mft²) | (Gal/mft²) | Reduction |
| 1 | 2.0 | 0.8 | 897.6 | 359.0 | 60.0 |
| 2 | 2.7 | 1.2 | 1211.8 | 538.6 | 55.6 |
| 3 | 2.2 | 1.1 | 987.4 | 493.7 | 50.0 |

TABLE 2
Flow Impact Test Data at 45 Degree Flow

| | Input Flow | Output Flow | Input Flow | Output | |
|---|---|---|---|---|---|
| | Velocity | Velocity | Rate | Flow Rate | % Flow |
| Trial | (ft/s) | (ft/s) | (Gal/mft²) | (Gal/mft²) | Reduction |
| 1 | 3.2 | 0.3 | 1436.2 | 134.6 | 90.6 |
| 2 | 3.0 | 0.6 | 1346.4 | 269.3 | 80.0 |
| 3 | 3.3 | 0.6 | 1481.0 | 269.3 | 81.8 |

The flow impact test data show that with significant reduction in flow, the containment material remained intact and in position at either 45 degrees or 90 degrees to flow.

The oil spill containment tests involved adding either 100 or 200 ml of oil to about 70 l of water in the system and flowing the resulting mixture of oil and water against the containment material. In one trial, 100 ml of oil was added at a 45° contact angle, with a downstream flow. After 30 minutes of flow, 94% of the oil was retained behind the containment material. A drop in height of 4⅞″ was observed between the contaminant side and the deflection side.

In a second oil spill containment trial, 200 ml of oil was added at a 45° contact angle with 0.36 Knot upstream flow and 0.47 Knot downstream flow. After 12 minutes of flow, over 98% of the oil was retained behind the containment material. The oil that passed through, less than 2%, was a result of a small breakthrough under the containment material. A drop in height of only 2⅝″ was observed between the contaminant side and the deflection side.

In a third oil spill containment trial, 100 ml of oil was added at a 90° contact angle with 0.24 Knot upstream flow and 0.71 Knot downstream flow. After 30 minutes of flow, 94% of the oil was retained behind the containment material. No overflow was observed. A drop in height of 4¼″ was observed between the contaminant side and the deflection side.

The oil spill containment tests showed that a retention threshold on the containment material was around 0.20 ml crude oil per cm² for between 100 and 200 ml of oil in 70 l of water. The greatest retention rate was observed when the containment material is perpendicular to fluid flow. The velocity threshold was reached at about 0.5 knots.

The standing water oil containment showed over 99% retention with no visible breakthrough after 5 days. In this test, 100 ml of oil was added to the system and no change in height was observed on either side of the containment material.

Examples Only

In the preceding description, for purposes of explanation, numerous details are set forth in order to provide a thorough understanding of the embodiments. However, it will be apparent to one skilled in the art that these specific details are not required.

The above-described embodiments are intended to be examples only. Alterations, modifications and variations can be effected to the particular embodiments by those of skill in the art without departing from the scope, which is defined solely by the claims appended hereto.

1-26. (canceled)

27. A boom comprising:
a plurality of buoyant spars, the buoyant spars each comprising:
a buoyant portion for providing buoyancy in a body of water; and
a ballast portion for orienting the spars in the body of water; and
a plurality of sections of a containment material, each section extending for a section length between neighboring buoyant spars, the containment material comprising:
a deflection layer permeable to water and having a low permeability for a selected contaminant; and
a first containment layer connected with the deflection layer, the first containment layer permeable to water and having a low permeability for the selected contaminant;
wherein the containment material has a tensile strength and permittivity to water for containing the contaminant in water at a selected flow rate;
the buoyant spars provide buoyancy to locate the containment layer in the body of water at a selected height above a surface of the body of water and a selected depth below the surface of the body of water; and
the containment material has a rigidity for remaining substantially vertical at the selected height above the surface of the body of water along the section length between neighboring buoyant spars.

28. The boom of claim 27 wherein the selected height above the surface of the body of water is substantially half of the selected depth below the surface of the body of water.

29. The boom of claim 27 further comprising at least one material attachment point on at least one section of the containment material.

30. The boom of claim 29 further comprising at least one upper material attachment point and at least one lower material attachment point on the at least one section of the containment material.

31. The boom of claim 27 further comprising at least one material attachment point on at least one buoyant spar.

32. The boom of claim 31 further comprising at least one upper material attachment point and at least one lower material attachment point on the at least one buoyant spar.

33. The boom of claim 27 further comprising at least one connection member extending along at least one section of the containment material.

34. The boom of claim 33 further comprising at least one upper connection member and at least one lower connection member on the at least one containment material section.

35. The boom of claim 27 wherein the containment material further comprises a support layer connected with the deflection layer and with the first containment layer for providing the rigidity.

36. The boom of claim 35 wherein the support layer is located intermediate the deflection layer and the first containment layer.

37. The boom of claim 36 wherein the support layer is directly connected with the first containment layer.

38. The boom of claim 36 wherein the support layer is directly connected with the deflection layer.

39. The boom of claim 38 wherein the support layer is connected with the deflection layer along substantially the entire extent of a height of the deflection layer.

40. The boom of claim 39 wherein the support layer is connected with the deflection layer along substantially the entire extent of a height of the support layer.

41. The boom of claim 39 wherein a height of the deflection layer is less than a height of the support layer.

42. The boom of claim 38 wherein:
the support layer is connected with the containment first layer along a portion of the height of the support layer for defining a containment zone between the containment first layer and the support layer;
the containment zone extends between a first point along the height of the support layer and a second point along the height of the support layer;
the first point is intermediate a first end of the support layer and a second end of the support layer.

43. The boom of claim 42 wherein the first point is located proximate the first end of the support layer.

44. The boom of claim 43 wherein the second point is located proximate the second end of the support layer.

45. The boom of claim 43 wherein the second point is located at a submerged point along the height of the support layer that would be located below a surface of a body of water in which the aquatic containment material may be located, the submerged point located intermediate the second end of the support layer and the first point.

46. The boom of claim 45 wherein a height of the deflection layer is less than a height of the support layer and the second point is coextensive with the deflection layer.

47. The boom of claim 35 further comprising a second containment layer intermediate the support layer and the deflection layer.

48. The boom of claim 47 further comprising a third containment layer intermediate the second containment layer and the deflection layer.

49. The boom of claim 48 wherein the third containment layer comprises a spunbond sorbent material.

50. The boom of claim 35 wherein the support layer comprises a geogrid.

51. The boom of claim 27 wherein the deflection layer comprises a woven geotextile.

52. The boom of claim 27 wherein the first containment layer comprises a spunbond sorbent material.

53. The boom of claim 27 wherein the first containment layer comprises a nonwoven geotextile.

54. The boom of claim 27 further comprising an absorbent material connected with the deflection layer for absorbing the contaminant.

55. The boom of claim 54 wherein the absorbent material extends from the deflection layer substantially perpendicular to a height of the containment material at a point along the height of the containment material corresponding to a surface of a body of water in which the containment material is deployed for contacting the surface of the body of water.

56. The boom of claim 27 wherein the contaminant comprises silt, hydrocarbons, algae, or industrial effluent.

57. The boom of claim 27 wherein the containment first layer comprises a material for sorbing the contaminant.

58. The boom of claim 27 wherein the selected shape is substantially vertical along a selected height above a portion of the containment material corresponding to a surface of a body of water in which the containment material is located.

59. The boom of claim 27 wherein the selected distance corresponds to a separation distance between neighboring support members for the containment material.

60. A method of containing a contaminant in a body of water comprising:
providing an aquatic containment material with a tensile strength and permittivity to water for containing the contaminant in the body of water at a selected flow rate across the containment material, and a rigidity for remaining substantially vertical at a selected height along a selected length between anchor points for the aquatic containment material, the aquatic containment material comprising:
a deflection layer permeable to water and having a low permeability for the selected contaminant; and
a containment layer connected with the containment letter, the containment layer permeable to water and having a low permeability for a selected contaminant;
locating the aquatic containment material in the body of water, with the deflection layer facing a contaminated portion of the body of water including at least a portion of the contaminant and with the containment layer facing open water with a lower concentration of the contaminant than the contaminated portion; and
securing the aquatic containment material in the body of water to restrict passage of the contaminant through the deflection layer and the containment layer, and across the aquatic containment material, for containing the contaminant.

61. The method of claim 60 wherein locating the aquatic containment material in the body of water comprises locating the aquatic containment material at least 6 inches above a surface of the water.

62. The method of claim 61 wherein locating the aquatic containment material in the body of water comprises locating the aquatic containment material between about 6 and about 24 inches above the surface of the water.

63. The method of claim 60 wherein locating the aquatic containment material in the body of water comprises securing the aquatic containment material between a series of floating spars.

64. The method of claim 63 wherein the aquatic containment material and the series of floating spars comprise the floating boom of any one of claims 27 to 59.

65. The method of claim 63 wherein locating the aquatic containment material in the body of water comprises towing the containment material through the body of water.

66. The method of claim 65 wherein the containment material comprises a support layer connected with the deflection layer and with the containment layer for providing the rigidity, and the containment layer the support layer is connected with the containment first layer along a portion of the height of the support layer for defining a containment zone between the containment first layer and the support layer, the method further comprising containing the contaminant in the containment zone.

67. The method of claim 66 wherein a surface contaminant is contained within the containment zone.

68. The method of claim 60 wherein locating the aquatic containment material in the body of water comprises anchoring the aquatic containment material to a floor of the water body, a shore, a buoy, or a combination thereof.

69. The method of claim 60 wherein the selected contaminant comprises silt, hydrocarbons, algae, or industrial effluent.

70-74. (canceled)
